(19) United States
(12) Patent Application Publication
(10) Pub. No.: US 2023/0118312 A1
(43) Pub. Date: Apr. 20, 2023

(54) SYSTEM AND METHOD OF PROMOTING AND VALIDATING A NON-FUNGIBLE TOKEN

(71) Applicant: Mint NFT, Inc., Bellevue, WA (US)

(72) Inventor: James SUN, Bellevue, WA (US)

(21) Appl. No.: 17/591,365

(22) Filed: Feb. 2, 2022

Related U.S. Application Data
(60) Provisional application No. 63/255,715, filed on Oct. 14, 2021.

(51) Int. Cl. G06Q 30/00; G06Q 30/08; G06Q 20/38

(52) U.S. Cl. CPC G06Q 30/018; G06Q 30/08; G06Q 20/389; G06Q 2220/10

(57) ABSTRACT

A computer-implemented method of providing real time authentication of a non-fungible token (NFT). The method includes: receiving a user selection of an NFT; retrieving underlying digital asset of the selected NFT; displaying the underlying digital asset; and displaying a digital certificate while the underlying digital asset is displayed; wherein the digital certificate is made only available when the NFT is authenticated.

### CROSS REFERENCE TO RELATED APPLICATIONS

The present application claims the benefit of U.S. Provisional Application No. 63/255,715, filed on Oct. 14, 2021, the entirety of which is hereby incorporated by reference.

### FIELD

This relates generally to a system and method of promoting and validating non-fungible tokens (NFTs), and more particularly, to a computer-implemented method of providing real-time authentication of an NFT.

### BACKGROUND

A NFT is a unit of data stored on a digital ledger (i.e., a blockchain) that certifies a digital asset to be unique and therefore not fungible. NFTs can be used to represent digital items such as photos, videos, audio, etc. Each NFT may represent a different underlying asset and thus have a different value. NFTs are created when blockchains string records of cryptographic hash, a set of characters identifying a set of data, onto previous records therefore creating a chain of identifiable data blocks. This cryptographic transaction process ensures the authentication of each digital file by providing a digital signature that is used to track NFT ownership.

NFTs are gaining popularity. NFTs of digital art and collectibles have sold for substantial amounts of money via auctions and dedicated platforms. However, NFT auctions and platforms in their current forms are single dimensional and static without an integrated community or social influence. They are detached and not designed to create excitement to bring in new users to the NFT community or provide an effective way to promote NFTs within the existing community.

Furthermore, there is no easy way for an NFT owner to manage and promote his or her collection of NFTs. Many NFT owners are not sure about what to do with their NFT collections. This is at least partly due to the lack of a simple mechanism for the NFT owners to show or promote their collections of NFTs effectively. In particular, there is no existing mechanism to demonstrate the authenticity of an NFT while presenting the underlying NFT-certified digital asset. This can limit the potential of NFT and the value of NFT-certified assets.

### SUMMARY

In one aspect, a computer-implemented method of providing real time authentication of a non-fungible token (NFT). The method includes: activating an app on a user device; receiving a user selection of an NFT; performing authentication of the NFT; retrieving underlying digital asset of the NFT; displaying the underlying digital asset; displaying a digital certificate while the underlying digital asset is being displayed; activating a camera on the user device; taking a picture of the audience of the NFT; extracting and storing viewer data and other information associated with the viewing of the NFT; updating information associated with the NFT; and optionally, transmitting viewer data and other information associated with the viewing of the NFT to a sponsor.

In a second aspect of the disclosure, a video authentication method of NFTs and, in particular, intellectual property (“IP”) rights in the NFTs is disclosed.

In another aspect, this disclosure relates to a system and method of hosting a live virtual event (e.g., virtual auction) for promoting NFTs and conducting transactions of NFTs.

In yet another aspect, this disclosure relates to a NFT card (a.k.a. Black Card) that can track and manage a user's NFTs and information related thereto.

### BRIEF DESCRIPTION OF THE DRAWINGS

FIG. 1 illustrates the exemplary components of a system for managing NFTs, according to an embodiment of the disclosure.

FIG. 2 illustrates an exemplary screen shot of the app showing in real time a digital asset and a digital certificate certifying the digital asset, according to an embodiment of the disclosure.

FIG. 3 is a flow chart illustrating the exemplary steps in a method of providing real time authentication of an NFT-certified digital asset via an app, according to an embodiment of the disclosure.

FIGS. 4a-4d illustrates different formats of live NFT events that a user can participate via an NFT app, according to an embodiment of the disclosure.

FIG. 5 illustrates an exemplary interface of a live auction being run on the app, according to an embodiment of the disclosure.

FIG. 6 is a flow chart illustrating the exemplary steps in a method of authenticating an NFT and the IP rights in the NFT, according to an embodiment of the disclosure.

FIG. 7 illustrates the exemplary steps in creating an NFT card, according to an embodiment of the disclosure.

FIG. 8 illustrates exemplary physical NFT cards, according to embodiments of the disclosure.

### DETAILED DESCRIPTION OF THE PREFERRED EMBODIMENTS

In the following description of preferred embodiments, reference is made to the accompanying drawings which form a part hereof, and in which it is shown by way of illustration specific embodiments, which can be practiced. It is to be understood that other embodiments can be used and structural changes can be made without departing from the scope of the embodiments of this disclosure.

In a first aspect of the disclosure, a system and method of authenticating an NFT in real time is provided. As referred to hereinafter, the term “NFT” can be used for describing an NFT and the digital asset that is certified by the NFT. Auctions of NFTs have generated significant interests and some NFTs have gained large valuation through sales. Nevertheless, many owners of NFTs are often confused about what to do with the NFTs they acquired. In particular, there is easy way for NFT owners to share and promote their collections of NFTs.

The underlying digital asset of an NFT can be a photo, video, sound clip, or any other types of digital file. NFTs can also represent digital collectibles such as physical card collections in a digital format. Due to them being in digital format, one of the advantages of NFTs is that they can be shown quite easily on any electronic device such as a smartphone or a computer. For example, an owner of an NFT can simply take out his phone and display the digital art from his NFT collection. Nevertheless, a problem exists in that, when the owner shows a digital asset from his NFT collection, there is no existing mechanism to demonstrate that it is in fact an NFT (i.e., a unique non-fungible copy of the asset) owned by the owner. That is, the owner has no way of proving that the copy he is showing is in fact the original one and only certified NFT rather than a copy of the underlying digital art that can be downloaded from the internet and has little value.

Given that the underlying digital asset of an NFT may be easily duplicated in many cases, the value of the NFT is tied to the fact that the copy certified by the NFT is guaranteed to be a unique non-fungible copy through the use of a blockchain. It, thus, is essential for the owner of an NFT to be able to share his NFT in a way that reflects the authenticity of the NFT. Without being able to provide authentication in real time, the uniqueness and the true value of the NFT may not be appreciated as they should be. This could in turn make NFTs less desirable as collectibles and make acquiring NFTs less compelling to a lot of people. Therefore, a method of providing real time authentication of an NFT is needed.

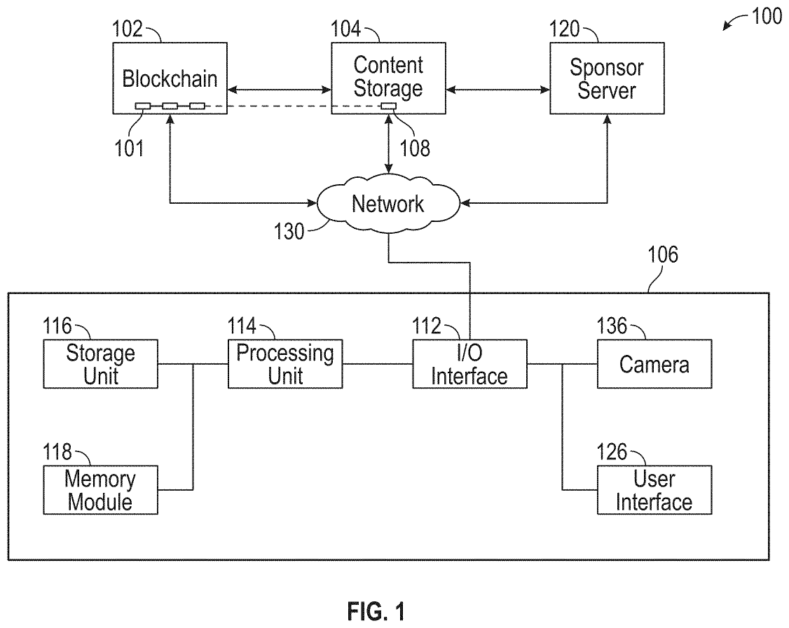

FIG. 1 illustrates the exemplary components of a system 100 for managing NFTs. The system 100 can include a blockchain 102 such as Ethereum, a content storage 104, and a user device 106. Optionally, the system 100 can also include a sponsor server 120. The blockchain 102, content storage 104, user device 106 and the optional sponsor server 120 can be connected to one another via a network 130. When an NFT 101, which is essentially a document with a hash, is minted, it can be stored on the blockchain 102. Blockchain is a well-known technology that has been widely used in many areas including, for example, crypto currency and smart contracts and, thus, is not described in detail here. There are many blockchain platforms, among which Ethereum is currently most often used for NFTs. However, it should be understood that blockchain 102 can be any blockchain platform.

The NFT 101 can point to the content storage 104, which is where the underlying digital content 108 associated with the NFT 101 lives at the time the NFT was minted. The content storage 104 can be a cloud server or any other type of network storage device capable of storing digital content. The content 108 can be any digital file such as a photo, video, audio, etc. The content can be virtual asset or a digital copy of a physical asset. While there may be other copies of the content 108 across the internet, the copy 108 on the content storage 104 is a unique and non-fungible copy because it is certified by the NFT 101.

In one embodiment, the content 108 may be sponsored by a sponsor. For example, the sponsor can be SONY, which owns the right on the comic character, Spiderman. The sponsor can give permission to a content creator to create digital art of Spiderman by granting the creator the necessary license. In the example of FIG. 1, the NFT-certified content 108, once created, can also be linked to the sponsor via the sponsor server 120. The sponsor server 120 can be any type of network computer connected to the content storage 104. As will be discussed below, the sponsor server 120 can receive and process certain information associated with the NFT 101 and the associated content 108.

The owner of the NFT 101 can access the digital content 108 on the content storage 104 from a user device 106. The user device 106 can be any electronic device connected to the network 130 and capable of accessing the content storage 104 and retrieving the digital content 108. As illustrated in FIG. 1, the user device 106 may include, among other things, an I/O interface 112, a processing unit 114, a storage unit 116, and a memory module 118.

I/O interface 112 may also be configured for two-way communication with other components of the user device 106, such as user interface 126, and camera 136. I/O interface 102 may also send and receive data to and from devices such as content storage 108, sponsor server 120, and/or blockchain 102 via network 130. Network 130 may be any type of wired or wireless network that may facilitate transmitting and receiving data. For example, network 130 may be a nationwide cellular network, a wide area network, a local wireless network (e.g., Bluetooth or WiFi), and/or a wired network.

Processing unit 114 may be configured to receive signals and process the signals to determine a plurality of conditions of the operation of user device 106. Processing unit 114 may also be configured to generate and transmit command signals, via I/O interface 112, to actuate the devices such as camera 136 and user interface 126.

Storage unit 116 and/or memory module 118 may be configured to store one or more computer programs that may be executed by processing unit 114 to perform functions of the user device 106. For example, storage unit 116 and/or memory module 118 may be configured to store an app configured to manage the user's NFT collection. Storage unit 116 and/or memory module 118 may be further configured to store data and/or look-up tables used by the processing unit 114. Storage unit 116 and memory 118 can be non-transitory computer-readable medium storing instructions which, when executed, cause one or more processors to perform the method, as discussed below. The computer-readable medium can include volatile or non-volatile, magnetic, semiconductor, tape, optical, removable, non-removable, or other types of computer-readable medium or computer-readable storage devices. The computer-readable medium can have computer instructions stored thereon, as disclosed. In some embodiments, the computer-readable medium may be a disc or a flash drive having the computer instructions stored thereon.

In one embodiment, the user device 106 can store and run an app that is configured to manage the user's NFTs. The app can provide a way for the user to search and retrieve a copy of his NFT-certified digital assets from the content storage 104. In addition, the app can also allow the user to participate in NFT-related events.

In one embodiment, the user can use the app to retrieve his NFT-certified digital asset 108 from the content storage 104. When the asset 108 is retrieved, an authentication step can be performed at either the content storage 104 or a separate authentication server (not shown in FIG. 1) to verify that the digital asset 108 is associated with NFT 101 on the blockchain 102, which in turn verifies the user's ownership of the NFT 101. If this authentication step is successful, a copy of the digital asset 108 can be retrieved from the content storage 104 and displayed in the app on the user device 106. In some embodiments, the content storage 104 and the user device 106 can be the same device and the digital asset 108 can reside at the user device 106. In this case, the app can simply retrieve the digital asset 108 from a local storage (e.g., storage unit 116).

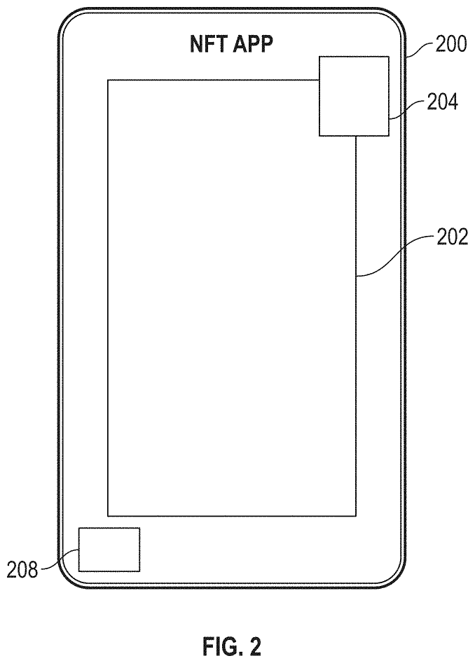

FIG. 2 illustrates an exemplary screen shot of the app 200 showing a digital asset 202. In addition, the app 200 can display a digital certificate 204 along with the retrieved copy of the digital asset 202 to indicate that the asset 202 is an authenticate NFT owned by the user of the app 200. The digital certificate 204 can be in the form of an image, an animation, a video clip, a sound clip, etc. For example, an NFT of a Lebron James baseball card can have a digital certification in the form of a pre-recorded video clip of a personal message from Lebron James. The video clip can be subject to copyright protection and would not be made available on any other platforms (e.g., apps or websites). Because the digital certificate 204 being presented is unique and only available through the app, it would be instantly recognized as proof that the asset being shown in the app is an NFT and not an ordinary copy of the same. This can help the owner of the NFT generate interest when he shows off the NFT on his device to others.

Additionally, the app 200, when displaying the digital asset 202 and the digital certificate 204, can activate the camera 136 on the user device 106. The camera 136 can capture an image of the person or people (the “audience”) to whom the user is showing the NFT. In one embodiment, the camera 136 can be activated in response to a user command (e.g., the user selecting a camera icon 208 in the app 200). In another embodiment, the camera 136 can be activated automatically when the NFT-certified digital art 202 is presented on the user device 106. The camera 136 can automatically detect human face(s) using facial recognition technology and capture an image of the audience's face(s). It should be noted that, if there are multiple cameras on the user device, the camera on the display side facing the audience is activated so when the display displays the NFT-certified digital asset, the camera is facing the audience.

After the face(s) of the audience are captured by the camera, the app 200 can determine whether the audience is a first-time viewer of the particular NFT 202 and store an image of the viewer's face in a database if it is of a first-time viewer. Additionally or alternatively, the app 200 can track, for example, the total number of views of the NFT 202 and the number of unique views (views by each different viewer) of the NFT 202. The app 200 can also update a social score associated with the NFT 202 based on the total number of views and/or the number of unique views. The social score can be a way of measuring the popularity of the NFT. In addition, the app can also capture date/time data, location data, and other background and/or viewer data each time the NFT is viewed on the user device 106. All this data can be analyzed to generate information about the audience of the NFT and the NFT's exposures in the community in general. This data can optionally be transmitted and stored on the sponsor server 120 and used in targeted marketing/advertising campaigns by the sponsor of the particular NFT-certified digital asset. It can also be used by non-sponsors for similarly purposes. Additionally, every time the NFT-certified asset is viewed, its social score can increase, sometime significantly if, for example, the NFT has been viewed by celebrities or had exposures in a movie or other large events. A high social score can potentially have a positive effect on the value of the NFT.

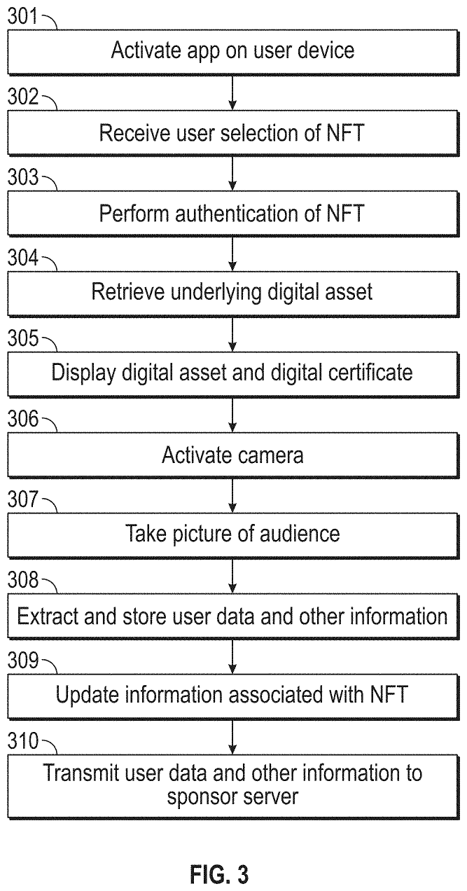

FIG. 3 is a flow chart illustrating the exemplary steps in a method of providing real time authentication of an NFT-certified digital asset via an app. First, the app is activated on the user device (step 301). A selection of an NFT from the user's NFT collection is then received by the app (step 302). The app can perform an authentication step on the NFT to verify that the user of the app owns the NFT (step 303). Once authenticated, a copy of the underlying digital asset can be retrieved from a content storage (step 304). The digital asset is displayed along with a digital certificate unique to the NFT and only accessible through the app (step 305). The app can activate a camera on the user device (step 306). The camera can take a picture of the audience viewing the NFT-certified digital asset being displayed in the app (step 307). User data from the picture and other information relating to the viewing of the NFT can be extracted and stored by the app (step 308). Optionally, the app can update information such as social score associated with the NFT (step 309). Optionally, the app can transmit user data and other viewing data to a sponsor server (step 310). It should be understood that although the steps of FIG. 3 are illustrated in a particular order, some of the steps may take place simultaneously or in an order different from the one shown in the FIG. 3. Some of the steps may be optional.

In some embodiments, the app can also allow the user to post a copy of the NFT-certified digital asset in an online community. The social score of the NFT can be updated based on a number of predetermined factors including but not limited to the number of views of the NFT, the number of unique views of the NFT, the number of likes and/or comments received from viewers, the number of special endorsements (e.g., views and/or likes by celebrities), and the number of redirections from the app to the sponsor's content.

The app can also become a part of a flatform that allows fans to generate their own NFTs in relations to a campaign launches by a sponsor (e.g., an asset/IP owner). For example, SONY can run a campaign to allow fans to submit Spiderman derivative work. Once approved, NFTs of the original derivative work can be minted and the creator and the sponsor can share profit generated from a sale of the NFT and/or other income (e.g., advertising revenue) generated from viewings of the NFT.

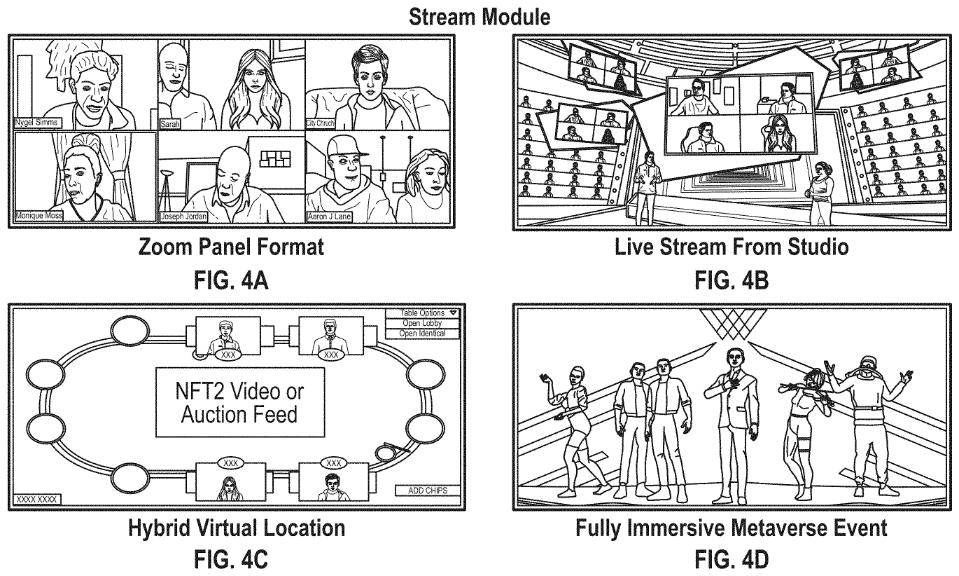

In a second aspect of the disclosure, the app can provide a way for the app user to participate in NFT related activities. Such activities can include live events such as virtual auctions. The app user can register and/or purchase tickets for an event via the app. The events can be hosted and/or sponsored by the sponsor of certain NFT-certified digital assets. In one embodiment, the event ticket can be an NFT or be bundled with an NFT, which can be stored and retrieved via the app. Inside the app, live events can go on in different formats. For example, the live event can be an auction in Zoom format attended by real participants (FIG. 4a). Alternatively, the live event can be live streamed from a studio (FIG. 4b). In another embodiment, the live event can be hosted in a hybrid virtual location (FIG. 4c). In yet another embodiment, the live event can be a fully immersive metaverse event, which can be presented in a virtual reality (FIG. 4d).

In the virtual reality format shown in FIG. 4d, participants can move around in a virtual or fully immersive environment and interact with avatars of other participants. The sponsor of the event can incorporate its name/brand or advertisements in the event. This, in a way, adds authenticity to the event and the NFTs being auctioned in the event in that the sponsorship can certify that the NFTs come with the underlying IP rights (e.g., copyright).

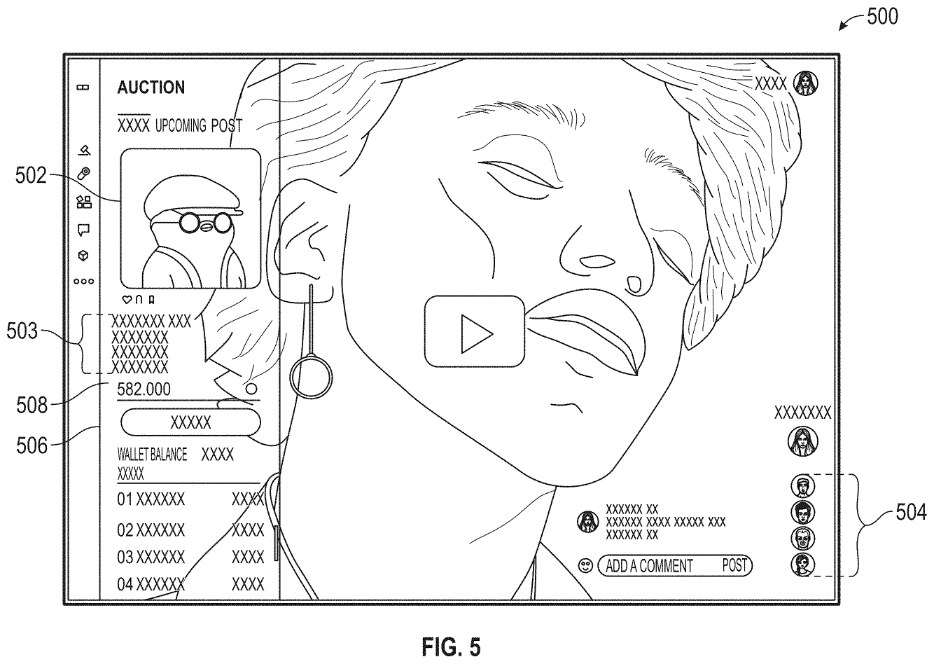

FIG. 5 illustrates an exemplary interface 500 of a live auction being run on the app. When the user joins a live auction on the app, the app can display a lot of the NFTs being auctioned 502 along with general information 503 about the NFTs such as NFT Name, NFT Info, Scarcity, Bid, Bid history, Winner, and Winning Bid (if the auction of the NFT has ended). In addition, the auction interface 500 can also include a chat room 504 that allows participants of the auction to engage in live discussion. The interface can also include a bidding interface 506 that allows the user to submit a bid for the NFT being auctioned. An optional “Like it” button 508 can be provided for the user to “like” the NFT being auctioned. The social score of the NFT will increase every time it receives a “like” or a bid during the auction. In some embodiments, celebrities can be invited to participate in the live auction and chat about the NFTs while the NFTs are being auctioned. The social score of the NFT can also increase in response to input from celebrity participants.

During or after the live event, a video link to the event can be provided over the app or a website so participants and nonparticipants of the event can watch a video of the event. This is another way of increasing exposure for the NFTs and the sponsor of the event.

In a third aspect of the disclosure, a method of authenticating an NFT and, in particular, the IP rights in the underlying digital asset of the NFT is provided. Intellectual property or IP, as referred herein, is in general a type of property that provides its owner certain exclusive rights in the property. IP can be in protected in many different forms including patent, trademark, trade secret, copyright, and trade dress.

While NFTs are guaranteed by the blockchain technology used for minting them to be unique and non-fungible, the fact that a digital asset is an NFT does not automatically guarantee that the owner/creator has the rights in the IP of the digital asset itself. For example, without a license from SONY, a digital art depicting Spider-man may be in violation of SONY's copyright in the comic character even though an NFT of this digital art is authentic in terms of its uniqueness. In other words, a buyer of the NFT would not necessarily be able to acquire the IP rights associated with the digital art underlying the NFT when he acquires ownership of NFT. This can be a problem for certain potential NFT buyers/collectors and make NFTs a less desirable asset. To remedy this problem, a method of authenticating the NFT and IP rights in the underlying digital asset is disclosed in the paragraphs below.

In one embodiment, a video clip or link can be attached to an NFT as proof that the NFT comes with the requisite IP rights in the underlying digital asset. As discussed above, various types of NFT events such as auctions can enable NFT transactions and promote NFT popularity. Very often the sponsor of these events can include the IP owners of the underlying assets of the NFTs. A video clip showing an IP owner-sponsored NFT event can confirm that the NFTs being presented at the event come with all the IP rights in the underlying digital assets.

In one embodiment, the video clip can be a live video stream of an event that has a representative of the sponsor providing live authentication of the IP rights in the NFT. In another embodiments, the video clip can be recorded and includes a message from the IP-owning sponsor guaranteeing full IP rights in the NFTs to which the video clip is attached to. In yet another embodiment, the video clip can include the story behind the NFTs that addresses the underlying IP rights. In yet another embodiment, the video clip can include an actual NFT visual (e.g., a photo of video of the NFT) to directly associate the video clip to the NFT. These IP authenticating videos can be stored centrally on a server such as the sponsor server 120 of FIG. 1 or decentralized over a network. If a video includes segments directed to and addressing the IP rights in particular NFTs, the video can be edited such that each corresponding segment of the video is associated with a corresponding NFT.

Because videos, especially videos of live events, are relatively difficult to forge, they are an ideal way of confirming that the underlying assets of the NFTs come with proper IP rights. In some embodiments, the video clip/link as a certification of IP rights can be associated with the corresponding NFT when the NFT is newly minted. In other embodiments, the video clip/link can be associated with the corresponding NFT at a later time. For example, an owner of an NFT can request the IP owner of the underlying digital asset to provide a video clip after he has secured the IP rights from the IP owner in an NFT that had been minted without first securing the IP rights. Additionally or alternatively, a physical legal contract can be attached to the video clip via a link. The physical legal contract can be between the NFT owner and the IP owner of the underlying digital asset and providing further authenticity of the NFT owner's ownership of the NFT and the associated IP rights. The original copy of the physical legal contract can be stored in a safe location such as a centralized vault. Although video, video links and video clips are mentioned herein as a type of digital content that can be used for confirming the IP rights of NFTs, it should be understood that other formats can also be used to achieve the same purpose so long as such other formats can have the same or similar level of confidence to the target audience.

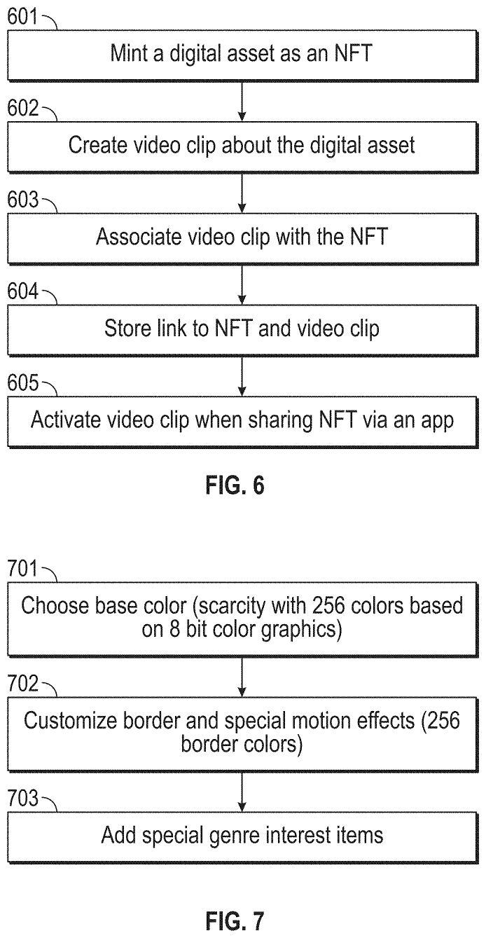

Referring to FIG. 6, the exemplary steps in confirming IP rights in an NFT is illustrated. First, a digital asset can be minted as an NFT (Step 601). A video clip about the digital asset can be created (Step 602). The video clip can include confirmation of the grant of the IP rights to the creator of the digital asset, which in a way certifies that the NFT comes with the necessary IP rights. Additionally or alternatively, the video clip can include an actual visual (e.g., photo or video) of the NFT to associate the NFT with the video. Step 602 can take place around the same time as Step 601 or at a later time. The video clip is then processed and associated with the NFT (Step 603). In one embodiment, a unique identifier referencing the video clip can be generated. The unique identifier can be a number, a set of numbers, a uniform resource locator (URL), an IP address, a database, etc. The unique identifier can be stored in the smart contract of the NFT. The owner of the NFT can use the unique identifier to reference the video. A link to the NFT and the associated video clip can be stored and made available for viewing via an app (Step 604). The video clip can be made accessible only by using the unique identifier. Because only the owner of the NFT has access to the unique identifier in the smart contract, this can provide a way to prove the authenticity of the ownership of the NFT. In one embodiment, a third-party server can act as a proxy to retrieve the video clip using the unique identifier. The owner of the NFT can activate the video clip to show evidence of property IP rights in the NFT when showing the NFT via the app (Step 605). When the NFT changes ownership, a new video clip or video clips can be created as evidence of the transaction. The new video can be linked to the unique identifier in the smart contract and retrieved using the unique identifier when needed.

In a fourth aspect of the disclosure, a NFT card is disclosed. The NFT card (also referred to as the “Black Card”) can provide an NFT owner the ability to track his loyalty points and social points in relation to his collection of NFTs. An NFT owner can link his NFTs and/or crypto to his NFT card. The NFT card can give the consumer access to online/virtual events such as the virtual auctions described above.

A user can obtain a NFT card in one or more different ways. In one embodiment, when user signs up for the app, he can create his own NFT card. The NFT card can be customizable. A digital copy of the card can be minted as an NFT, which can be transferred to another user. In one embodiment, each user can only have one NFT card at any given moment.

The NFT card can keep track of the user's NFT-related activities. For example, it can track royalty points as the user visits the NFT network (e.g., if they attend an auction, like an item, bid on an item, or receive likes, participate conversation or other social interactions). FIG. 7 illustrates the exemplary steps in creating an NFT card, according to an embodiment of the disclosure. First, the user can choose base color (e.g., scarcity with 256 colors based on 8-bit color graphics) (Step 701). There can be higher scarcity for certain colors like black which will create the fear-of-missing-out (FOMO) effect. Then, the user can customize border and special motion effects (e.g., 256 border colors) (Step 702). Finally, the user can add special genre interest items (see examples illustrated in FIG. 7) (Step 703).

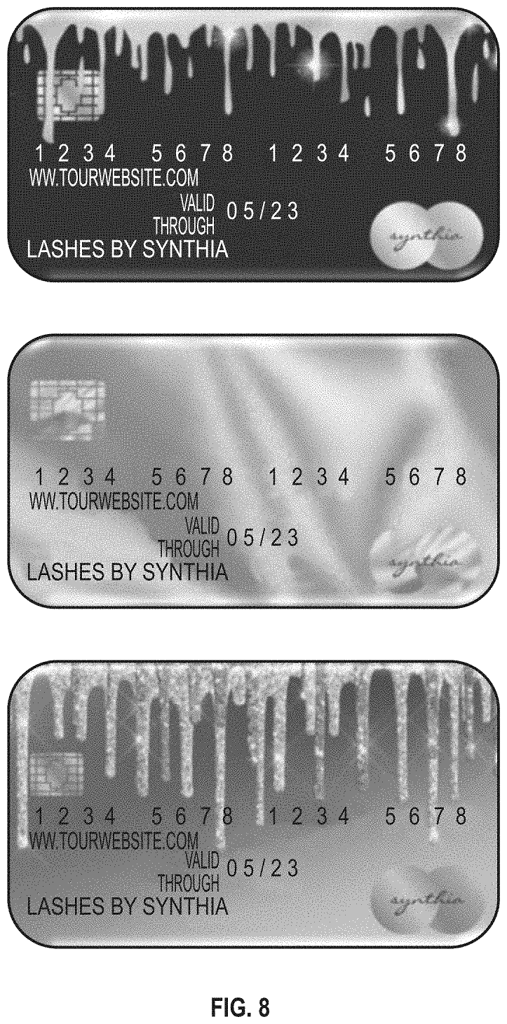

A corresponding physical NFT Card (examples provided in FIG. 8) can be issued in addition or as an alternative to the digital NFT card. In some embodiments, the physical NFT card can have an embedded QR code, hologram, NFC chip, or any other suitable medium for storing digital information. The physical NFT card can contain on its digital medium digital information associated with the user's NFT account in the app. In particular, the digital information on the physical NFT card can allow the user to access his NFT collection on the blockchain. The physical NFT card can be kept in a safe place such as a bank vault to serve as an offline access card to the NFTs in case its digital counterpart is offline.

The live events described above could be invitation only to the NFT card holders and participants is required to present their NFT cards to attend the events. Other optional features can also be provided to NFT card holders. For example, liquidity of some early random Black Cards for high valuations can be created. A celebrity Black Card viral story can be created. Certain Black Cards can be preloaded with crypto. Surprise Black Cards that give users a major prize can be offered to selected users.

Some of the advantages of the embodiments disclosed above can include converting first time user into NFT owner with initial Black Card, leveraging existing fan behavior of attending events and converting them to NFT collectors, increasing fan engagement from casual fans to tastemakers; incentivize repeat behavior with their NFT social scores increasing; leveraging social and loyalty points to keep users coming back to the platform; bringing users back using via email/text/in app notifications; giving users new events to keep their entertainment interests; and using gamification auction psychology for entertainment.

All of the methods and tasks described herein may be performed and fully automated by a computer system. The computer system may, in some cases, include multiple distinct computers or computing devices (e.g., physical servers, workstations, storage arrays, cloud computing resources, and mobile devices, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Although embodiments of this disclosure have been fully described with reference to the accompanying drawings, it is to be noted that various changes and modifications will become apparent to those skilled in the art. Such changes and modifications are to be understood as being included within the scope of embodiments of this disclosure as defined by the appended claims.

What is claimed is:

1. A computer-implemented method of authenticating a non-fungible token (NFT), the method comprising:
creating a video clip about the NFT;
associating the video clip with the NFT;
storing a link to the NFT and the video clip in a computer storage device; and
activating the video clip when displaying the NFT on an app.

2. The computer-implemented method of claim 1, wherein the video clip comprises proof that the NFT comes with the requisite IP rights in an underlying digital asset of the NFT.

3. The computer-implemented method of claim 2, wherein the proof comprises a message from an owner of the requisite IP rights confirming that the NFT comes with the requisite IP rights.

4. The computer-implemented method of claim 2, wherein the requisite IP rights comprises copyright in the underlying digital asset of the NFT.

5. The computer-implemented method of claim 2, wherein the proof comprises a live video stream of an event having a sponsor of the NFT providing live authentication of the requisite IP rights in the NFT.

6. The computer-implemented method of claim 2, wherein the proof comprises a story behind the NFT that addresses the requisite IP rights.

7. The computer-implemented method of claim 2, wherein the video clip comprising an actual NFT visual that associates the video clip to the NFT.

8. The computer-implemented method of claim 7, wherein the actual NFT visual comprises a photo of the NFT.

9. The computer-implemented method of claim 1, further comprising attaching a physical legal contract to the video clip via a link.

10. The computer-implemented method of claim 9, wherein the physical legal contract is between the owner of the NFT and the owner of the IP rights in the underlying digital asset of the NFT.

11. The computer-implemented method of claim 1, further comprises generating a unique identifier referencing the video clip; and storing the unique identifier in a smart contract of the NFT.

12. The computer-implemented method of claim 12, wherein the video clip is accessible only by using the unique identifier.

13. A computer-implemented method of providing real time authentication of a non-fungible token (NFT), the method comprising:
receiving a user selection of an NFT;
retrieving underlying digital asset of the selected NFT;
displaying the underlying digital asset; and
displaying a digital certificate while the underlying digital asset is displayed;
wherein the digital certificate is made only available when the NFT is authenticated.

14. The computer-implemented method of claim 13, further comprising performing authentication of the NFT prior to retrieving the underlying digital asset of the NFT.

15. The computer-implemented method of claim 14, wherein performing authentication of the NFT comprises retrieving information from a blockchain.

16. The computer-implemented method of claim 13, further comprising activating a camera and capture a photo of an audience of the NFT using the camera.

17. The computer-implemented method of claim 16, further comprising extracting user data from the photo;

18. The computer-implemented method of claim 17, further comprising extracting information comprising a date and time and a location of the photo.

19. The computer-implemented method of claim 18, further comprising updating a social score of the NFT based on the extracted user data and information.

20. The computer-implemented method of claim 19, further comprising transmitting the user data and information to a sponsor server.
